(19) United States
(12) Patent Application Publication
(10) Pub. No.: US 2018/0306414 A1
(43) Pub. Date: Oct. 25, 2018

(54) LAMPSHADE AND LAMP

(71) Applicants: LITE-ON ELECTRONICS (GUANGZHOU) LIMITED, GUANGZHOU (CN); Lite-On Technology Corporation, Taipei (TW)

(72) Inventors: Ching-Wen Chuang, Taipei (TW); Po-Chang Li, Taipei (TW); Ming-Hung Chien, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/913,923

(22) Filed: Mar. 7, 2018

Related U.S. Application Data
(60) Provisional application No. 62/489,449, filed on Apr. 24, 2017.

(30) Foreign Application Priority Data
Jan. 5, 2018 (TW) 107100416

(51) Int. Cl. F21V 17/00; F21V 9/00; F21V 3/04; F21V 17/12; F21V 31/00

(52) U.S. Cl. CPC F21V 17/002; F21V 9/00; F21V 31/00; F21V 17/12; F21V 3/049

(57) ABSTRACT

A lampshade including a frame and an optical function plate is provided. The frame includes an assembly portion. The optical function plate is detachably disposed to the frame through the assembly portion. Furthermore, a lamp including the above-mentioned lampshade is also provided.

### CROSS-REFERENCE TO RELATED APPLICATION

This application claims the priority benefit of U.S. provisional application Ser. No. 62/489,449, filed on Apr. 24, 2017 and Taiwan application serial no. 107100416, filed on Jan. 5, 2018. The entirety of each of the above-mentioned patent application is hereby incorporated by reference herein and made a part of this specification.

### BACKGROUND

### Technical Field

The disclosure relates to a lampshade and a lamp applying the lampshade.

### Related Art

Lamps used in the field of road lighting are mostly overhead lamps. When a lampshade of a street light is damaged or needs to be replaced, the replacement thereof has to be carried out high in the air. However, in the street light, the lampshade is generally connected to a main body of the lamp by sleeving onto the main body, which makes it relatively difficult to replace the lampshade high in the air.

In addition, according to different lighting requirements, different optical designs are correspondingly required for the lampshade. If it is need to manufacture lampshades having different optical designs, it would be necessary to use different molds correspondingly. This leads to excessively high development costs.

### SUMMARY

The disclosure provides a lampshade by applying which a lamp allows easier replacement of the lampshade and has lower development costs.

The disclosure provides a lamp including the above-mentioned lampshade, the lamp allowing easier replacement of the lampshade and having lower development costs.

One embodiment of the disclosure proposes a lampshade including a frame and an optical function plate. The frame includes an assembly portion. The optical function plate is detachably disposed to the frame through the assembly portion.

One embodiment of the disclosure proposes a lamp including a main body portion, a recessed portion, a light emitting unit and the above-mentioned lampshade. The recessed portion is connected to the main body portion and has an accommodating space. The light emitting unit is disposed in the accommodating space. The light emitting unit is adapted to emit at least one light beam. The lampshade is disposed in the recessed portion. The optical function plate is disposed on a transmission path of the light beam.

In one embodiment of the disclosure, the recessed portion includes an opening.

In one embodiment of the disclosure, an outer edge of the frame is complementary in shape to the opening.

In one embodiment of the disclosure, the frame is smaller than the opening, and a projection region of the frame onto the recessed portion is substantially identical to a projection region of the light emitting unit onto the recessed portion.

In one embodiment of the disclosure, the assembly portion includes at least one assembly slot. The optical function plate is slidably connected to the frame through the at least one assembly slot.

In one embodiment of the disclosure, the assembly portion includes an assembly opening. An outer edge of the optical function plate is complementary to an inner edge of the assembly opening.

In one embodiment of the disclosure, the frame further includes a plurality of positioning portions. The lampshade is adapted to be disposed on a lamp through these positioning portions.

In one embodiment of the disclosure, the lamp further includes a plurality of locking members. The recessed portion further includes a plurality of assembly holes, wherein each of the positioning portions is aligned with one of the assembly holes, and the locking members are respectively screwed into the positioning portions and the assembly holes to lock the frame to the recessed portion.

In one embodiment of the disclosure, the optical function plate includes a plurality of optical microstructures.

In one embodiment of the disclosure, the optical function plate further includes a filter material.

In one embodiment of the disclosure, the optical function plate includes a light transmissive cover.

In one embodiment of the disclosure, the lamp further includes a plurality of locking members. The frame further has a plurality of first positioning through holes. The light emitting unit further has a plurality of second positioning through holes. The locking members are respectively screwed into the first positioning through holes and the second positioning through holes to lock the frame to the light emitting unit.

In one embodiment of the disclosure, the lamp further includes a mesa portion. An outer edge of the mesa portion is complementary to the outer edge of the frame, and the frame is disposed on the mesa portion.

In one embodiment of the disclosure, the lamp further includes a plurality of locking members. The frame further has a plurality of first positioning through holes. The mesa portion further has a plurality of third positioning through holes. Each of the first positioning through holes is aligned with one of the third positioning through holes, wherein the locking members are respectively screwed into the first positioning through holes and the third positioning through holes to lock the frame to the mesa portion.

In one embodiment of the disclosure, the lamp further includes a waterproof frame. The waterproof frame is disposed between the frame and the light emitting unit, and the frame is disposed on the waterproof frame.

In one embodiment of the disclosure, the lamp further includes a plurality of locking members. The frame further has a plurality of first positioning through holes. The waterproof frame further has a plurality of fourth positioning through holes. Each of the first positioning through hole is aligned with one of the fourth positioning through holes, wherein the locking members are respectively screwed into the first positioning through holes and the fourth positioning through holes to lock the frame and the waterproof frame to the recessed portion.

Based on the above, in the lampshade according to an embodiment of the disclosure, the optical function plate is detachably disposed on the frame through the assembly portion of the frame, and the optical function plate can therefore be replaced more easily and quickly. Furthermore, the lampshade is capable of fulfilling different lighting requirements by replacement of optical function plates having different optical functions, so that development costs can be reduced. Since the lamp according to an embodiment of the disclosure has the above-mentioned lampshade, the lamp may enjoy the above-mentioned advantages.

To make the above features and advantages of the disclosure more comprehensible, several embodiments accompanied with drawings are described in detail as follows.

### BRIEF DESCRIPTION OF THE DRAWINGS

FIG. 1 is a schematic view of a lamp according to one embodiment of the disclosure.

FIG. 2 is a schematic view of assembly of the lamp in FIG. 1.

FIG. 3A to FIG. 3C are schematic views of assembly of a lampshade.

FIG. 4 and FIG. 5 are respectively schematic views of lampshades of different embodiments of the disclosure.

FIG. 6 is a schematic view of a lamp according to another embodiment of the disclosure.

FIG. 7 is a schematic view of assembly of the lamp in FIG. 6.

FIG. 8 is a schematic view of a lamp according to still another embodiment of the disclosure.

FIG. 9 is a schematic view of assembly of the lamp in FIG. 8.

FIG. 10 is a schematic view of a lamp according to another embodiment of the disclosure.

FIG. 11 is a schematic view of assembly of the lamp in FIG. 10.

FIG. 12 is a schematic cross-sectional view taken along sectional line I-I′ in FIG. 10.

FIG. 13 is a schematic view of a lamp according to still another embodiment of the disclosure.

FIG. 14 is a schematic view of assembly of the lamp in FIG. 13.

FIG. 15 is a schematic cross-sectional view taken along sectional line J-J′ in FIG. 13.

### DETAILED DESCRIPTION OF DISCLOSED EMBODIMENTS

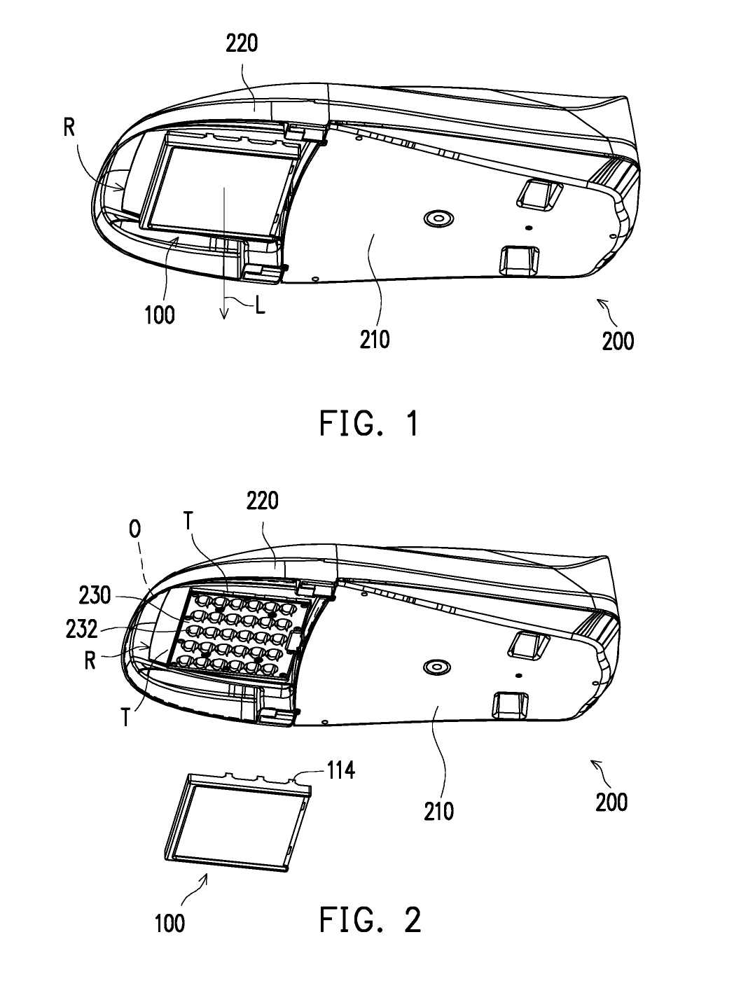

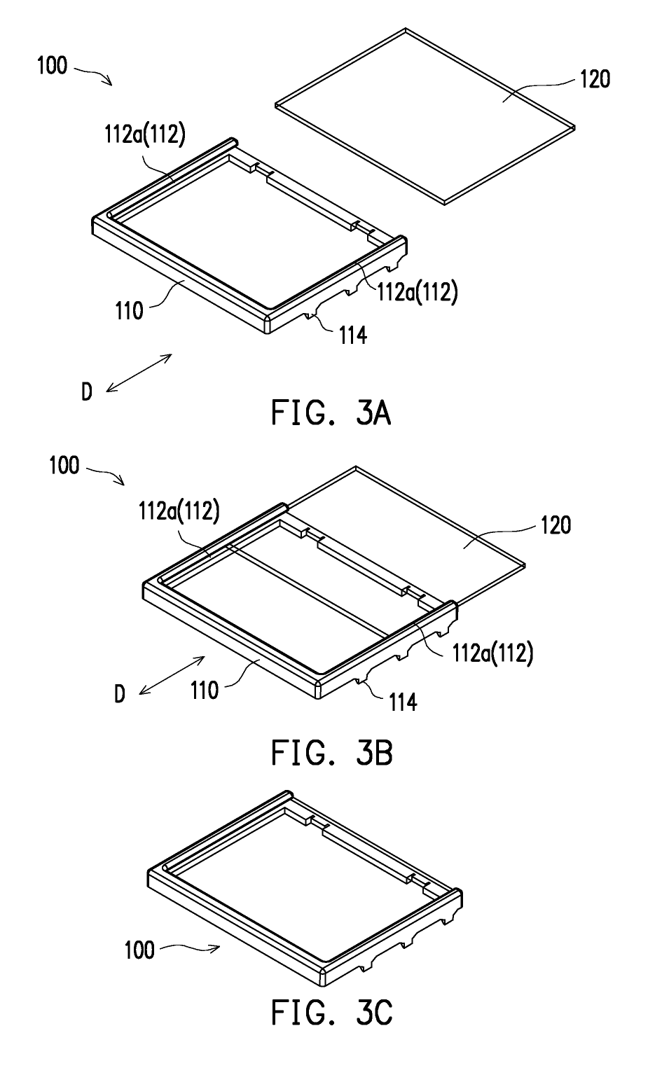

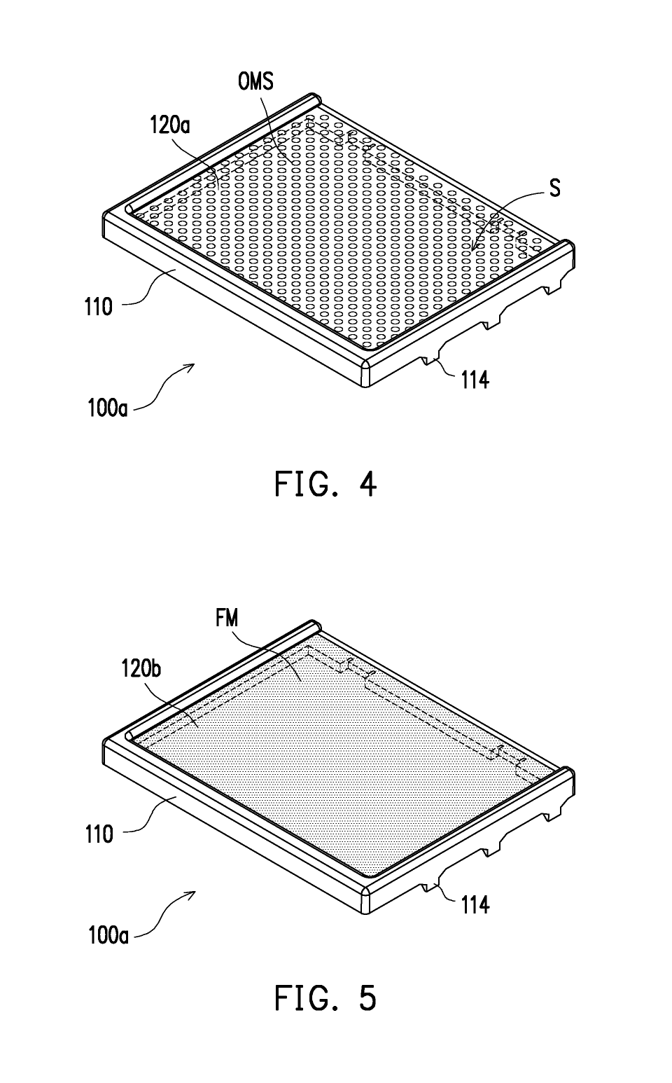

FIG. 1 is a schematic view of a lamp according to one embodiment of the disclosure. FIG. 2 is a schematic view of assembly of the lamp in FIG. 1. FIG. 3A to FIG. 3C are schematic views of assembly of a lampshade. FIG. 4 and FIG. 5 are respectively schematic views of lampshades of different embodiments of the disclosure.

Referring to FIG. 1 and FIG. 2, in the present embodiment, a lamp 200 is, for example, a street light. The lamp 200 includes a main body portion 210, a recessed portion 220, a light emitting unit 230 and a lampshade 100. The above-mentioned elements will be described in detail in the following paragraphs.

The main body portion 210 is connected to a pole (not shown) of the lamp 200 so as to be erected on a road. A controller (not shown) is disposed in the main body portion 210 to control the light emitting unit 230 to emit or not.

The recessed portion 220 is connected to the main body portion 210, and the recessed portion 220 is, for example, formed integrally with the main body portion 210. The recessed portion 220 has an accommodating space R. The light emitting unit 230 is disposed in the accommodating space R and is electrically connected to the recessed portion 220. The recessed portion 220 includes an opening O communicating with the containing space R.

The light emitting unit 230 includes a plurality of light emitting elements (not shown) and a plurality of lenses 232 (as shown in FIG. 2). The light emitting elements are controlled by the controller to be adapted to emit a light beam L, and the light emitting elements are implemented as, for example but not limited to, light emitting diodes. The lens 232 is correspondingly disposed on an optical path of one of the light emitting elements. The lenses 232 are configured to modify a light pattern of the light beam L. In the present embodiment, an outer edge of the light emitting unit 230 has a plurality of engagement slots T.

Referring to FIG. 3A to FIG. 3C, the lampshade 100 includes a frame 110 and an optical function plate 120. The frame 110 includes an assembly portion 112 and a plurality of positioning portions 114. The optical function plate 120 is detachably disposed on the frame 110 through the assembly portion 112. Specifically, in the present embodiment, the assembly portion 112 includes at least one assembly slot 112a, the at least one assembly slot 112a being, for example, two symmetrical assembly slots 112a. The optical function plate 120 may be slidably connected to the frame 110 in a direction D through these two assembly slots 112a, and is positioned by being stopped by the frame 110. In other words, the optical function plate 120 may be detachably disposed on the frame 110 in an extractable manner through the assembly slots 112a.

In another aspect, referring again to FIG. 2, the positioning portions 114 are implemented as, for example, fasteners. By engagement of the positioning portions 114 with the engagement slots T of the light emitting unit 230, the frame 110 is disposed in the recessed portion 220. The frame 110 is smaller than the opening O of the recessed portion 220. A projection region of the frame 110 onto the recessed portion 220 is substantially identical to a projection region of the light emitting unit 230 onto the recessed portion 220. The optical function plate 120 is disposed on a transmission path of the light beam L. The light beam L passes through the optical function plate 120 to be transmitted outside. In the present embodiment, the optical function plate 120 includes a light transmissive cover having functions of light transmission, dust protection and waterproofing. A material of the light transmissive cover is, for example but not limited to, glass.

It should be noted that part of the content of the aforesaid embodiment also applies to the following embodiments, and description of the same technical content will be omitted. Elements having the same reference numerals can be understood with reference to part of the content of the aforesaid embodiment, and description of these elements will not be repeated.

Referring to FIG. 4, a lampshade 100a in FIG. 4 is similar to the lampshade 100 in FIG. 1 and FIG. 2, and a main difference therebetween lies in that an optical function plate 120a includes a plurality of optical microstructures OMS. The optical microstructures OMS are, for example, protruding structures formed on a surface S of the optical function plate 120a. The lampshade 100a in FIG. 4 may be engaged with the recessed portion 220 in the manner similar to that depicted in FIG. 2. The optical function plate 120a in FIG. 4 may be assembled onto the frame 110 in the manner similar to that depicted in FIG. 3A to FIG. 3C. In the lampshade 100a of the present embodiment, by designing the optical function plate 120a to include the optical microstructures OMS, the light beam L emitted by the light emitting unit 230 can further be uniformly diffused. In one embodiment, the optical microstructures OMS may be recessed structures to correspondingly cause the light beam L to have a different light pattern design. The disclosure is not limited thereto. In another embodiment, the optical microstructures OMS may also be disposed inside the optical function plate 120a, and the disclosure is not limited thereto.

Referring to FIG. 5, a lampshade 100b in FIG. 5 is similar to the lampshade 100 in FIG. 1 and FIG. 2, and a main difference therebetween lies in that an optical function plate 120b further includes a filter material FM. The filter material FM is, for example, a substance capable of filtering light beams in a specific wavelength range and allowing light beams in other wavelength ranges to pass therethrough. In the present embodiment, the filter material FM is, for example, capable of filtering blue light in the light beam L. Thus, when the light beam L passes through the optical function plate 120b, the blue light in the light beam L is filtered, while yellow-green light or red light passes through the optical function plate 120b to meet a lighting requirement of filtering blue light (or low color temperature light). The disclosure does not limit what color light is filtered by the filter material FM. Similarly, the lampshade 100b in FIG. 5 may be engaged with the recessed portion 220 in the manner similar to that depicted in FIG. 2. The optical function plate 120b in FIG. 5 may be assembled onto the frame 110 in the manner similar to that depicted in FIG. 3A to FIG. 3C. In the lampshade 100b of the present embodiment, since the optical function plate 120b includes the filter material FM, the color temperature of the light beam L may be changed.

It is known from the above-mentioned several embodiments that, in the lampshade according to an embodiment of the disclosure, by replacing the optical function plate 120 having different optical functions, the light beam L may achieve different optical effects. The optical functions of the optical function plates 120, 120a and 120b are only described for exemplary purposes, and other optical functions may also be provided. The disclosure is not limited thereto.

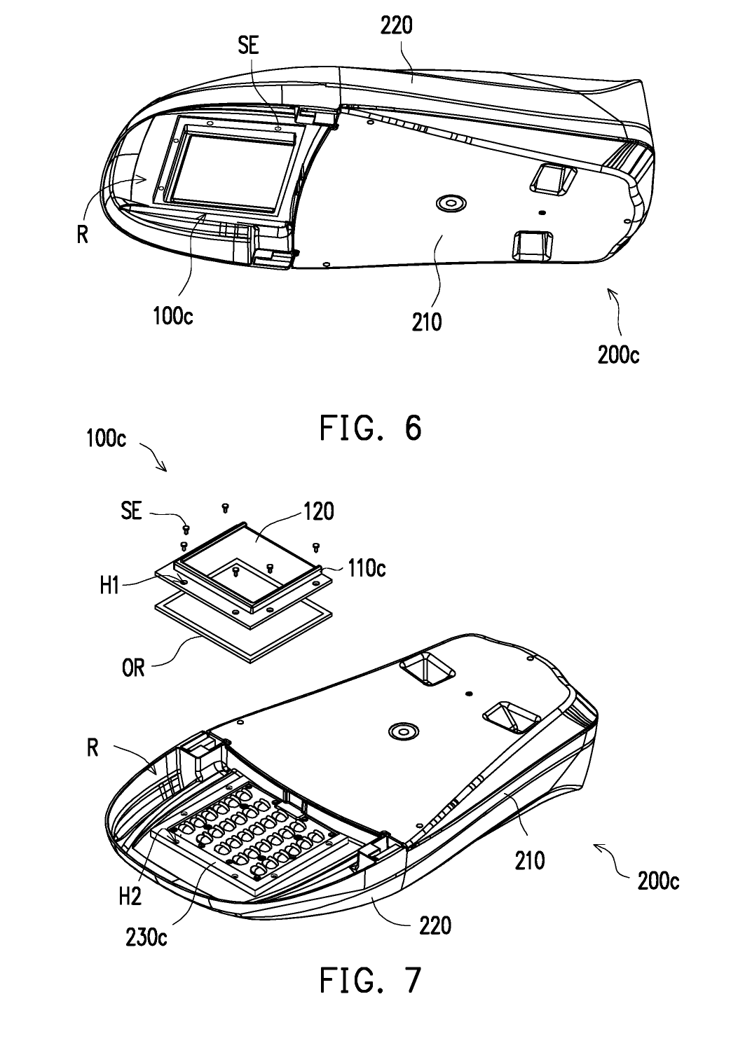

FIG. 6 is a schematic view of a lamp according to another embodiment of the disclosure. FIG. 7 is a schematic view of assembly of the lamp in FIG. 6.

Referring to FIG. 6 and FIG. 7, a lamp 200c in FIG. 6 and FIG. 7 is roughly identical to the lamp 200 in FIG. 1, and a main difference therebetween lies in that a lampshade 100c is disposed in the recessed portion 220 in a different manner. Specifically, the lamp 200c further includes a plurality of locking members SE and an O ring OR. The locking members SE are implemented as, for example but not limited to, screws. In other embodiments, the locking members SE are, for example, elements having similar functions, such as bolts, or hooks, or a combination thereof. The 0 ring OR is disposed between a frame 110c and a light emitting unit 230c. The frame 110c further has a plurality of first positioning through holes H1. The light emitting unit 230c has a plurality of second positioning through holes H2. Each of the first positioning through holes H1 is aligned with one of the second positioning through holes H2. That is to say, the first positioning through holes H1 are respectively aligned with the second positioning through holes. The locking members SE are respectively screwed into the first positioning through holes H1 and the second positioning through holes H2 to lock the frame 110c to the light emitting unit 230c.

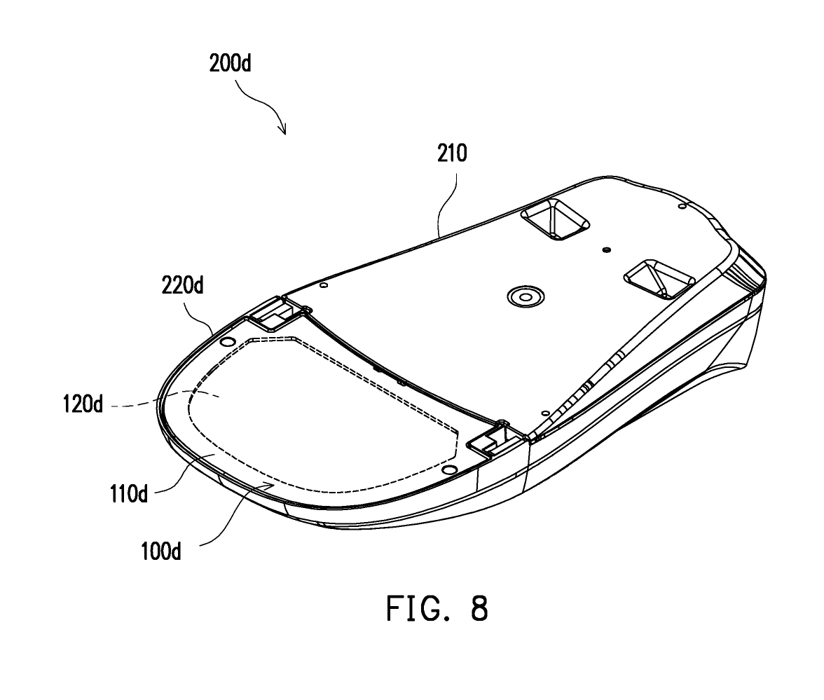

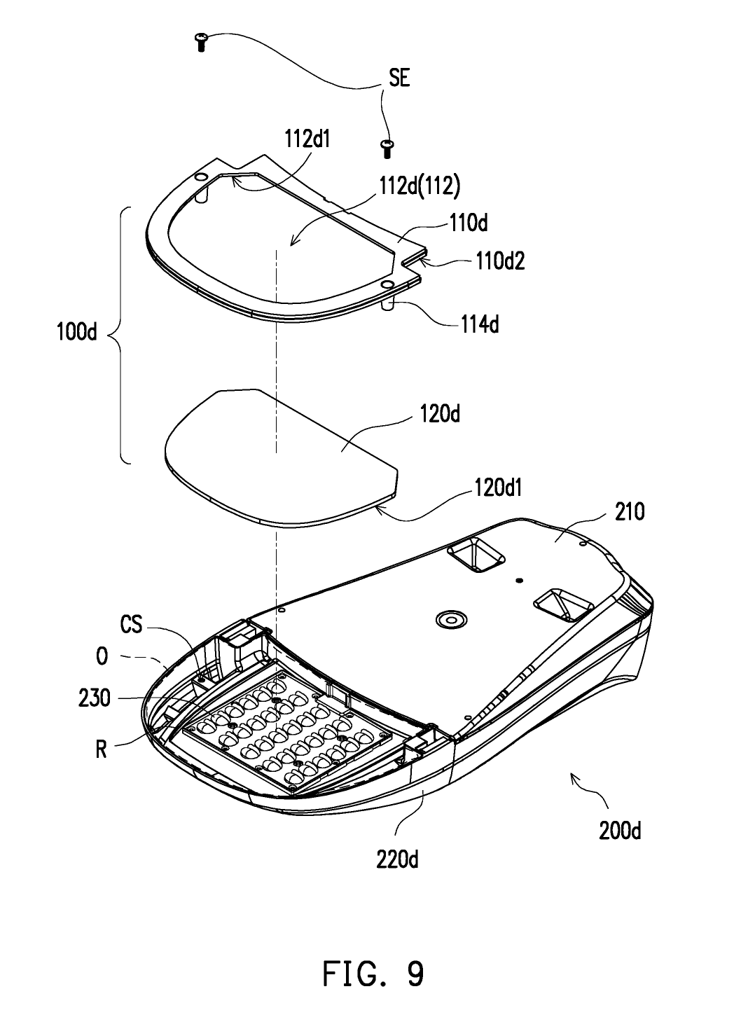

FIG. 8 is a schematic view of a lamp according to still another embodiment of the disclosure. FIG. 9 is a schematic view of assembly of the lamp in FIG. 8.

Referring to FIG. 8 and FIG. 9, a lamp 200d in FIG. 8 and FIG. 9 is roughly identical to the lamp 200 in FIG. 1, and a main difference therebetween lies in that the assembly portion 112 of a frame 110d includes an assembly opening 112d. An inner edge 112d1 of the assembly opening 112d is complementary to an outer edge 120d1 of an optical function plate 120d. Accordingly, the optical function plate 120d can be detachably disposed on the frame 110d by the above-mentioned design of complementary shapes and by being fitted into the assembly opening 112d. In addition, an outer edge 110d2 of the frame 110d is complementary in shape to the opening O. A projection region of the frame 110d onto a recessed portion 220d is larger than a projection region of the light emitting unit 230 onto the recessed portion 220d. The lamp 200d further includes a plurality of locking members SE. The frame 110d further includes a plurality of positioning portions 114d. Each of the positioning portions 114d is aligned with one of the assembly holes CS of the recessed portion 220d. The locking members SE are respectively screwed into the positioning portions 114d and the assembly holes CS to dispose the frame 110d into the recessed portion 220d.

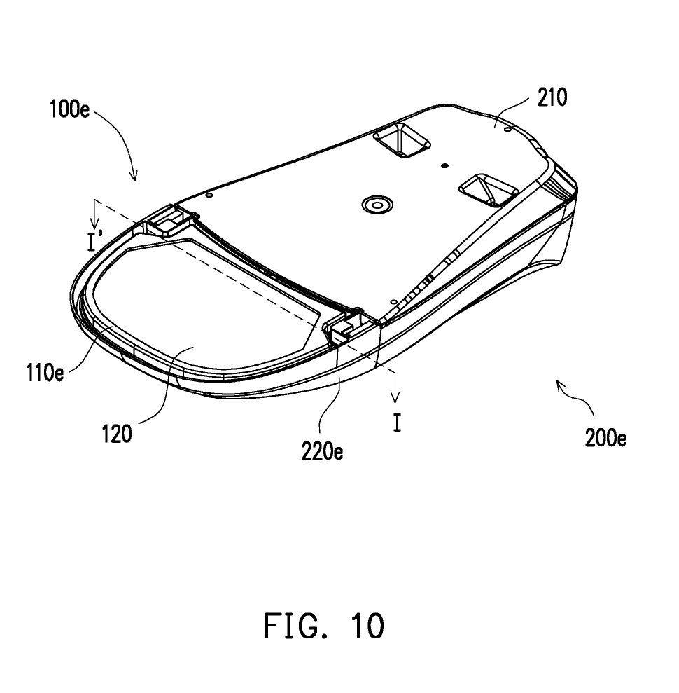

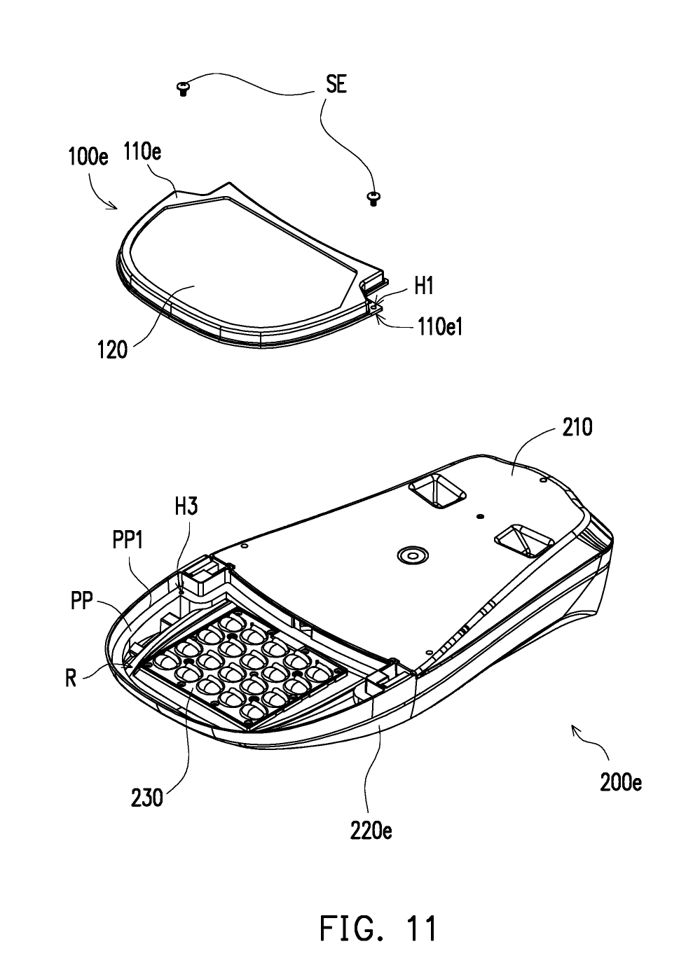

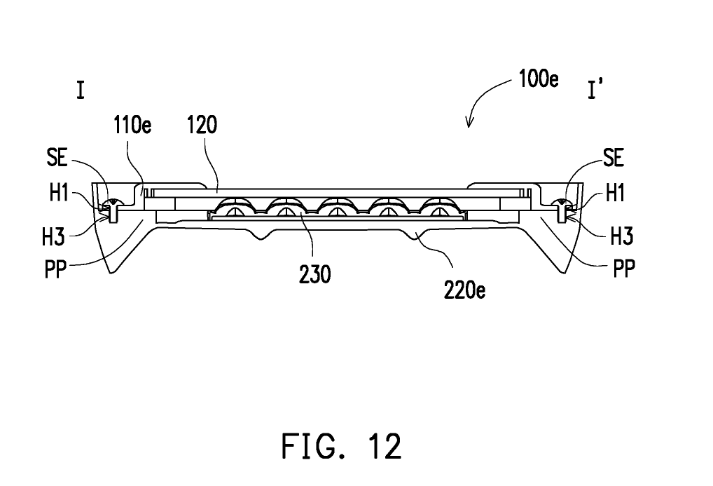

FIG. 10 is a schematic view of a lamp according to still another embodiment of the disclosure. FIG. 11 is a schematic view of assembly of the lamp in FIG. 10. FIG. 12 is a schematic cross-sectional view taken along sectional line I-I′ in FIG. 10.

Referring to FIG. 10 to FIG. 12, a lamp 200e in FIG. 10 to FIG. 12 is roughly identical to the lamp 200d in FIG. 8 and FIG. 9, and a main difference therebetween lies in that, in the present embodiment, a mesa portion PP is further disposed in a recessed portion 220e. An outer edge PP1 of the mesa portion PP is complementary to an outer edge 110e1 of a frame 110e. The frame 110e is disposed on the mesa portion PP. Specifically, the lamp 200e further includes a plurality of locking members SE. The frame 110e has a plurality of first positioning through holes H1. The mesa portion PP has a plurality of third positioning through holes H3. Each of the first positioning through holes H1 is aligned with one of the third positioning through holes H3. That's to say, the first positioning through holes H1 are respectively aligned with the third positioning through holes H3. The locking members SE are respectively screwed into the first positioning through holes H1 and the third positioning through holes H3 to lock the frame 110e to the mesa portion PP. In addition, in the lamp 200e of the present embodiment, the frame 110e and the mesa portion PP may further be glued together by a gel.

Following the above, in the lamp 200e of the present embodiment, since the frame 110e is locked to the mesa portion PP by the locking members SE, the frame 110e can be more tightly disposed in the recessed portion 220e. Thus, liquid or dust is relatively unlikely to enter space between a lampshade 100e and the recessed portion 220e to affect electrical characteristics of the light emitting unit 230. By the above-mentioned configuration, waterproofing and dust protection effects of the lamp 200e of the present embodiment, for example, may achieve a rating of IP66.

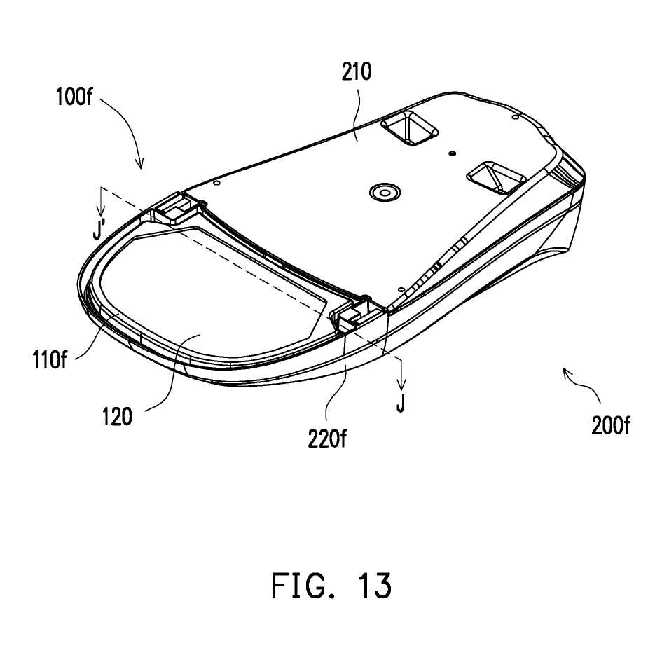

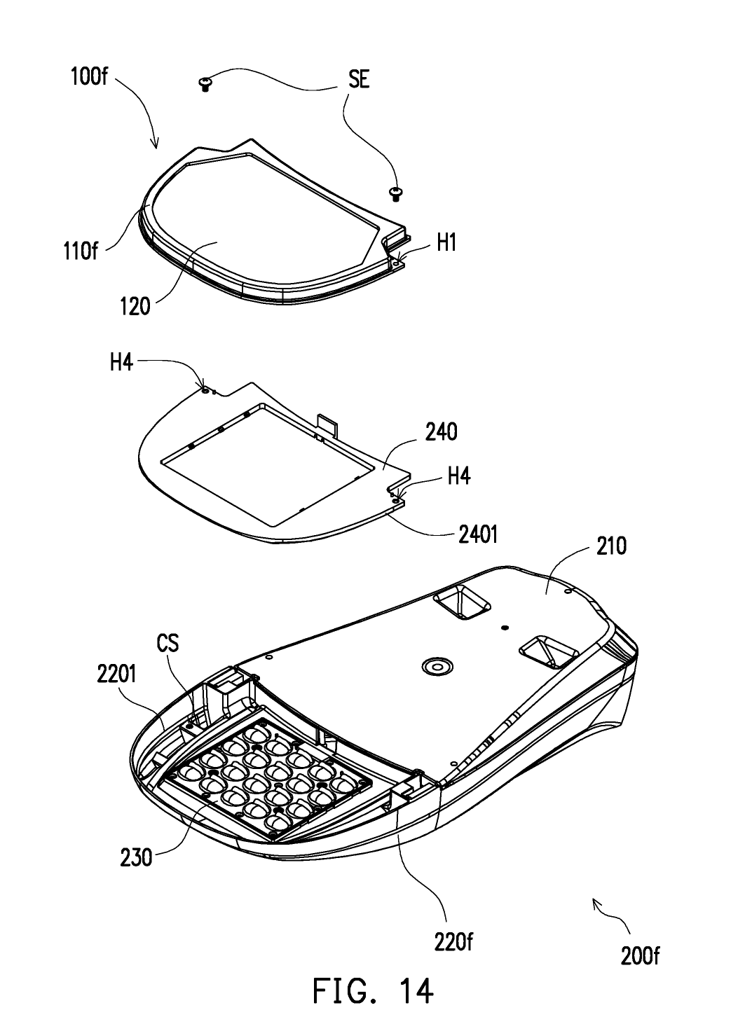

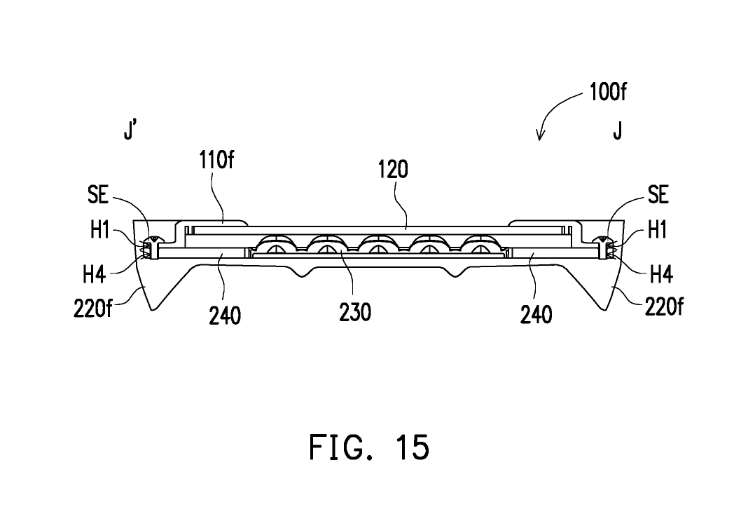

FIG. 13 is a schematic view of a lamp according to still another embodiment of the disclosure. FIG. 14 is a schematic view of assembly of the lamp in FIG. 13. FIG. 15 is a schematic cross-sectional view taken along sectional line J-J′ in FIG. 13.

Referring to FIG. 13 to FIG. 15, a lamp 200f in FIG. 13 to FIG. 15 is roughly identical to the lamp 200d in FIG. 8 and FIG. 9, and a main difference therebetween lies in that, in the present embodiment, a lamp 200f further includes a waterproof frame 240. The waterproof frame 240 is disposed between a frame 110f and the light emitting unit 230. An outer edge 2401 of the waterproof frame 240 is complementary to an inner wall 2201 of a recessed portion 220f. In addition, the lamp 200f further includes a plurality of locking members SE. The frame 120 has a plurality of first positioning through holes H1. The waterproof frame 240 has a plurality of fourth positioning through holes H4. Each of the first positioning through holes H1 is aligned with one of the fourth positioning through holes H4. That's to say, the first positioning through holes H1 are respectively aligned with the fourth positioning through holes H4. The locking members SE are respectively screwed into the first positioning through holes H1 and the fourth positioning through holes H4 to lock the frame 110f and the waterproof frame 240 into the assembly holes CS of the recessed portion 220f In addition, in the lamp 200f of the present embodiment, the waterproof frame 240 and the recessed portion 220f may further be glued together by a gel.

Following the above, in the lamp 200e of the present embodiment, the frame 110f and the waterproof frame 240 are locked to the recessed portion 220f by the locking members SE. By the above-mentioned configuration, the frame 110f and the waterproof frame 240 can be more tightly disposed in the recessed portion 220f, and moreover, the dust protection and waterproofing functions of the waterproof frame 240 can further be improved. Thus, liquid or dust is more unlikely to enter space between a lampshade 100f and the recessed portion 220f to affect electrical characteristics of the light emitting unit 230. By the above-mentioned configuration, waterproofing and dust protection effects of the lamp 200f of the present embodiment, for example, may also achieve a rating of IP66.

In summary, in the lampshade according to an embodiment of the disclosure, the optical function plate is detachably disposed on the frame through the assembly portion of the frame, and the optical function plate can therefore be replaced more easily and quickly. For example, the optical function plate may be detachably disposed on the frame in an extractable manner through the assembly slot; alternatively, by designing the outer edge of the optical function plate and the inner edge of the frame to have complementary shapes and by fitting the optical function plate to the frame, the optical function plate may be detachably disposed on the frame. Furthermore, according to the above-mentioned configuration, the lampshade according to an embodiment of the disclosure may fulfill different lighting requirements by replacement of the optical function plates having the same shape and different optical functions. Compared to the related art in which lampshades having different optical functions are manufactured using different molds, the process of manufacturing the optical function plates having different optical functions is relatively easy and rarely requires a mold. Therefore, the number of development molds can be reduced and development costs can be reduced. In another respect, the optical function plates respectively having different optical functions may have fixed sizes and specifications to accelerate product development. Since the lamp according to an embodiment of the disclosure has the above-mentioned lampshade, the lamp may enjoy the above-mentioned advantages.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A lampshade, comprising:
a frame, comprising an assembly portion; and
an optical function plate, detachably disposed to the frame through the assembly portion.

2. The lampshade of claim 1, wherein the assembly portion comprises at least one assembly slot, and the optical function plate is slidably connected to the frame through the at least one assembly slot.

3. The lampshade of claim 1, wherein the assembly portion comprises an assembly opening, and an outer edge of the optical function plate is complementary to an inner edge of the assembly opening.

4. The lampshade of claim 1, wherein the frame further comprises a plurality of positioning portions, and the lampshade is adapted to be disposed on a lamp through the positioning portions.

5. The lampshade of claim 1, wherein the optical function plate comprises a plurality of optical microstructures.

6. The lampshade of claim 1, wherein the optical function plate further comprises a filter material.

7. The lampshade of claim 1, wherein the optical function plate comprises a light transmissive cover.

8. A lamp, comprising:
a main body portion;
a recessed portion, connected to the main body portion, the recessed portion having an accommodating space;
a light emitting unit, disposed in the accommodating space, the light emitting unit being adapted to emit at least one light beam; and
a lampshade, disposed in the recessed portion, the lampshade comprising:
a frame, comprising an assembly portion; and
an optical function plate, detachably disposed to the frame through the assembly portion, and the optical function plate being disposed on a transmission path of the light beam.

9. The lamp of claim 8, wherein the recessed portion comprises an opening.

10. The lamp of claim 9, wherein an outer edge of the frame is complementary in shape to the opening.

11. The lamp of claim 9, wherein the frame is smaller than the opening, and a projection region of the frame onto the recessed portion is substantially identical to a projection region of the light emitting unit onto the recessed portion.

12. The lamp of claim 8, wherein the assembly portion comprises at least one assembly slot, and the optical function plate is slidably connected to the frame through the at least one assembly slot.

13. The lamp of claim 8, wherein the assembly portion comprises an assembly opening, and an outer edge of the optical function plate is complementary to an inner edge of the assembly opening.

14. The lamp of claim 8, wherein the frame further comprises a plurality of positioning portions, and the lampshade is disposed in the recessed portion of the lamp through the positioning portions.

15. The lamp of claim 14, wherein the lamp further comprises a plurality of locking members, the recessed portion further comprises a plurality of assembly holes, each of the positioning portions is aligned with one of the assembly holes, and the locking members are respectively screwed into the positioning portions and the assembly holes to lock the frame to the recessed portion.

16. The lamp of claim 8, wherein the optical function plate comprises a plurality of optical microstructures.

17. The lamp of claim 8, wherein the optical function plate further comprises a filter material.

18. The lamp of claim 8, wherein the optical function plate comprises a light transmissive cover.

19. The lamp of claim 8, further comprising a plurality of locking members, wherein the frame further has a plurality of first positioning through holes, the light emitting unit further has a plurality of second positioning through holes, each of the first positioning through holes is aligned with one of the second positioning through hole, and the locking members are respectively screwed into the first positioning through holes and the second positioning through holes to lock the frame to the light emitting unit.

20. The lamp of claim 8, wherein the recessed portion further comprises a mesa portion, an outer edge of the mesa portion is complementary to an outer edge of the frame, and the frame is disposed on the mesa portion.

21. The lamp of claim 20, further comprising a plurality of locking members, wherein the frame further has a plurality of first positioning through holes, the mesa portion further has a plurality of third positioning through holes, each of the first positioning through hole is aligned with one of the third positioning through holes, and the locking members are respectively screwed into the first positioning through holes and the third positioning through holes to lock the frame to the mesa portion.

22. The lamp of claim 8, further comprising a waterproof frame, wherein the waterproof frame is disposed between the frame and the light emitting unit, and the frame is disposed on the waterproof frame.

23. The lamp of claim 22, further comprising a plurality of locking members, wherein the frame further has a plurality of first positioning through holes, the waterproof frame further has a plurality of fourth positioning through holes, each of the first positioning through holes is aligned with one of the fourth positioning through holes, and the locking members are respectively screwed into the first positioning through holes and the fourth positioning through holes to lock the frame and the waterproof frame to the recessed portion.
